(19) United States
(12) Patent Application Publication
(10) Pub. No.: US 2004/0054077 A1
(43) Pub. Date: Mar. 18, 2004

(54) Thermoplastic resin composition having excellent chemical resistance and easy vacuum formability

(76) Inventors: Jong Hoon Chung, Kyonggi-do (KR); Sung Kook Kim, Kyonggi-do (KR); Jin Hwan Choi, Kyunggi-do (KR); Kyung Nam Lee, Kyunggi-do (KR)

Correspondence Address: Maria Parrish Tungol, Suite 600, 1800 Diagonal Road, Alexandria, VA, 22314, US

(21) Appl. No.: 10/451,028

(22) PCT Filed: Sep. 27, 2001
(86) PCT No.: PCT/KR01/01621

(30) Foreign Application Priority Data
Dec. 21, 2000 (KR) 200079629

(51) Int. Cl. C08L 51/08

(52) U.S. Cl. 525/63

(57) ABSTRACT

The resin composition according to the present invention comprises (A) a graft polymer prepared by grafting in emulsion polymerization 100 parts by weight of monomer mixture comprising 20-30% by weight of vinyl cyanide compound and 70-80% by weight of vinyl aromatic compound to 20-60 parts by weight of diene rubber, (B) a graft polymer prepared by grafting in emulsion polymerization 100 parts by weight of monomer mixture comprising 20-30% by weight of vinyl cyanide compound and 70-80% by weight of vinyl aromatic compound to 20-60 parts by weight of acrylic rubber, (C) a linear copolymer prepared by polymerizing 40-50% by weight of vinyl cyanide compound and 50-60% by weight of vinyl aromatic compound, and (D) a branched copolymer prepared by 30-35% by weight of vinyl cyanide compound and 65-70% by weight of vinyl aromatic compound.

### FIELD OF THE INVENTION

The present invention relates to a thermoplastic resin composition having good chemical resistance and easy vacuum formability. More particularly, the present invention relates to a thermoplastic resin composition which is capable of forming an internal box of a refrigerator having good physical properties, easy vacuum formability, and excellent freon resistance, especially excellent resistance to HCFC 141b.

### BACKGROUND OF THE INVENTION

The housing of a refrigerator is manufactured by assembling an internal box and an external box wherein a space between the two boxes is filled with a rigid polyurethane foam. Usually the external box is made of a steel sheet, and the internal box is made of a sheet of resin materials by a vacuum forming process. The rigid polyurethane foam has a role of a thermal insulator, which is formed by injecting a liquid polyurethane and a foaming agent.

An acrylonitrile-butadiene-styrene (hereinafter ABS) resin has been mainly employed for the internal box of a refrigerator. For commercial use, the ABS resin usually contains styrene-acrylonitrile (SAN) copolymers therein. An ABS resin can be obtained by grafting a monomer mixture comprising from 10 to 40% by weight of a vinyl cyanide compound and from 90 to 60% by weight of an aromatic vinyl compound to a diene rubber. The SAN copolymer is a polymer prepared by polymerizing from 10 to 40% by weight of a vinyl cyanide compound and from 90 to 60% by weight of an aromatic vinyl compound. Generally, SAN resin has a linear structure.

The ABS resin containing SAN copolymers has been used for preparing an internal box of a refrigerator, because the resin has a good balance of physical properties such as rigidity and impact resistance, easy vacuum formability, excellent glossy appearance, and excellent resistance to CFC 11 which is used as a foaming agent of polyurethane. Because CFC 11 threatens destruction of the ozone layer in the stratosphere, CFC-11 is being replaced with HCFC 141b at the present time.

However, HCFC 141b has a problem in that a stress crack appears on the internal box of a refrigerator by dissolving the resin component. There have been significant efforts and researches to solve the problem. The present inventors had developed a thermoplastic resin composition having good physical properties and excellent resistance to HCFC 141b thereby being employed for the internal box of a refrigerator which uses HCFC 141b as a foaming agent (Korean Paten No. 199,246, U.S. Pat. No. 5,747,587 and Japanese Patent No. 2,843,799). However, said resin composition has a drawback in vacuum formability which cause a sheet for an internal box of a refrigerator to be thick.

Accordingly, the present inventors have developed a thermoplastic resin composition which is capable of forming an internal box of a refrigerator having good physical properties, easy vacuum formability, and excellent freon resistance, especially to HCFC 141b by adding a branched copolymer of vinyl cyanide compound and aromatic vinyl compound.

### OBJECTS OF THE INVENTION

An object of this invention is to provide a thermoplastic resin composition having a good balance of physical properties such as rigidity and impact resistance, and no color change phenomenon during a molding process.

Another object of the invention is to provide a thermoplastic resin composition having good vacuum formability.

A further object of the invention is to provide a thermoplastic resin composition which is highly resistant to HCFC 141b.

A further object of the invention is to provide a thermoplastic resin composition which is capable of forming an internal box of a refrigerator which uses HCFC 141b as a foaming agent.

These and additional objects can be achieved by the resin compositions according to the present invention.

### SUMMARY OF THE INVENTION

The resin composition according to the present invention comprises (A) a graft polymer prepared by grafting in emulsion polymerization 100 parts by weight of monomer mixture comprising 20-30% by weight of vinyl cyanide compound and 70-80% by weight of aromatic vinyl compound onto 20-60 parts by weight of diene rubber, (B) a graft polymer prepared by grafting in emulsion polymerization 100 parts by weight of monomer mixture comprising 20-30% by weight of vinyl cyanide compound and 70-80% by weight of aromatic vinyl compound onto 20-60 parts by weight of acrylic rubber, (C) a linear copolymer prepared by polymerizing a monomer mixture comprising 40-50% by weight of vinyl cyanide compound and 50-60% by weight of aromatic vinyl compound, and (D) a branched copolymer prepared by polymerizing a monomer mixture comprising 30-35% by weight of vinyl cyanide compound and 65-70% by weight of aromatic vinyl compound, wherein the ratio by weight of (A)+(B) to (C)+(D) is from 50:50 to 20:80, the ratio by weight of (A) to (B) is from 10:1 to 1:1, and the ratio by weight of (C) to (D) is from 10:1 to 5:1.

The thermoplastic resin composition according to the present invention may be preferably employed in preparing the internal boxes of refrigerators, which are manufactured using HCFC 141b as a foaming agent, due to easy vacuum formability, good balance of physical properties such as rigidity and impact resistance, and no color change phenomenon during a molding process as well as excellent resistance to HCFC 141b. The detailed descriptions of the present invention are as follows.

### DETAILED DESCRIPTION OF THE INVENTION

The thermoplastic resin composition of the present invention comprises (A) a graft polymer prepared by grafting a monomer mixture comprising vinyl cyanide compound and aromatic vinyl compound onto a diene rubber, (B) a graft polymer prepared by grafting a monomer mixture comprising vinyl cyanide compound and a aromatic vinyl compound onto an acrylic rubber, (C) a linear copolymer prepared by polymerizing a monomer mixture of 40-50% by weight of vinyl cyanide compound and 50-60% by weight of aromatic vinyl compound, and (D) a branched copolymer prepared by polymerizing a monomer mixture of 30-35% by weight of vinyl cyanide compound and 65-70% by weight of aromatic vinyl compound. The components (A), (B), (C) and (D) will be described in detail hereinafter.

(A) Graft Polymer of Vinyl Cyanide Compound and Aromatic Vinyl Compound to Diene Rubber

The graft polymer is prepared by mixing 100 parts by weight of a monomer mixture of a vinyl cyanide compound and an aromatic vinyl compound and 20-60 parts (on the basis of solids content) by weight of a diene rubber and by grafting in a conventional emulsion polymerization the monomer mixture to the diene rubber. The monomer mixture contains 20-30% by weight of a vinyl cyanide compound and 70-80% by weight of an aromatic vinyl compound. Polymer made by the monomer mixture exists as a polymer matrix phase. And, the polymer matrix phase contains 20-30% by weight of the vinyl cyanide compound. In this invention, the content of grafted polymer onto the diene rubber would be preferably 40-70% by weight based upon the total weight of the graft polymer (A).

The diene rubber to be used for the preparation of the graft polymer (A) includes polybutadiene, polyisoprene, polychloroprene, a butadiene-styrene copolymer, and a butadiene-acrylonitrile copolymer. Among them, polybutadiene, a butadiene-styrene copolymer, and a butadiene-acrylonitrile copolymer may be preferably used. The average rubber particle size of the diene rubber is preferably in the range of 0.1-0.6 μm, more preferably 0.2-0.5 μm. The average rubber particle size of a diene rubber affects directly impact strength and glossy appearance of a resin composition. If the average rubber particle size is less than 0.1 μm, the resin composition cannot provide a sufficient impact strength. On the other hand, if the average rubber particle size exceeds 0.6 μm, the glossy appearance is deteriorated. Therefore, the average rubber particle size of the conjugated diene rubber should be in the range of 0.1-0.6 μm.

The content of the grafted polymer onto the diene rubber affects physical properties of the final resin composition such as impact strength and tensile strength. In this invention, the content of the grafted polymer onto the conjugated diene rubber would be preferably 40-70% based upon the total weight of the graft polymer (A). Further, the monomer mixture should contain 20-30% by weight of a vinyl cyanide compound in order to obtain the well balanced physical and chemical properties of the final products. If the monomer mixture contains less than 20% by weight of a vinyl cyanide compound, the final resin composition provides poor impact strength because the graft polymer (A) has an insufficient compatibility with a copolymer (C) and a copolymer (D) which will be described hereinafter. On the other hand, if the monomer mixture contains more than 30% by weight of a vinyl cyanide compound, the final resin composition shows a color change phenomenon during an extrusion process, although a freon resistance of the resin composition improves.

Specific examples of the vinyl cyanide compound for preparing the graft polymer (A) are acrylonitrile, methacrylonitrile and the like. These vinyl cyanide compounds can be used alone or in combination.

Specific examples of the aromatic vinyl compound for preparing the graft polymer (A) are styrene, alpha-methylstyrene, para-methylstyrene, vinylxylene, monochlorostyrene, dichlorostyrene, vinylnaphthalene and the like. These aromatic vinyl compounds can be used alone or in combination.

(B) Graft Polymer of Vinyl Cyanide Compound and Aromatic Vinyl Compound to Acrylic Rubber

The graft polymer (B) is prepared by grafting 100 parts by weight of a monomer mixture of a vinyl cyanide compound and an aromatic vinyl compound onto 20-60 parts (on the basis of solids content) by weight of an acrylic rubber by a conventional emulsion polymerization. The monomer mixture comprises 20-30% by weight of a vinyl cyanide compound and 80-70% by weight of an aromatic vinyl compound. Polymer made by the monomer mixture exists as a polymer matrix phase and the polymer matrix phase contains 20-30% by weight of the vinyl cyanide compound. The content of grafted polymer onto the acrylic rubber would be preferably 40-70% based upon the total weight of the graft polymer (B).

The acrylic rubber to be used for the preparation of the graft polymer (B) is preferably prepared by emulsion polymerization of alkyl acrylate monomers having 2-8 carbon atoms. A graft polymer of grafting a vinyl cyanide compound and an aromatic vinyl compound to an acrylic rubber has a strong resistance HCFC 141b. The average rubber particle size of the acrylic rubber is preferably in the range of 0.05-0.5 a, more preferably 0.1-0.3 μm. In order to provide a resin composition with excellent impact strength, the average particle size of the acrylic rubber should be smaller than that of the diene rubber. The larger the particle size of the acrylic rubber is, the lower stability of polymerization is.

The vinyl cyanide compound and the aromatic vinyl compound for preparing the graft polymer (B) are the same as described above for preparing the graft polymer (A).

(C) Linear Copolymer of 40-50% by Weight of Vinyl Cyanide Compound and 60-50% by Weight of Aromatic Vinyl Compound

The copolymer (C) having 38-45% by weight of a vinyl cyanide compound is prepared by copolymerizing 40-50% by weight of a vinyl cyanide compound and 60-50% by weight of an aromatic vinyl compound. The weight average molecular weight of the copolymer determined by GPC (gel permeation chromatography) is preferably in the range of 100,000-200,000, and the molecular weight distribution (M_{w}/Mₙ; weight average molecular weight/number average molecular weight) is preferably in 1.8-2.5.

In regard to the copolymer (C), the content of the vinyl cyanide compound affects a freon resistance, and the molecular weight and molecular distribution of the copolymer affect physical properties of the resin composition and a sheet forming processability. If the copolymer contains a vinyl cyanide compound less than 38% by weight, the final resin composition gives a stress crack on a molded article because of a poor resistance to HCFC 141b. On the other hand, if the copolymer contains a vinyl cyanide compound more than 45% by weight, an over-load is applied during an extrusion process and a color change occurs. And, if the weight average molecular weight of the copolymer is less than 100,000, physical properties such as tensile strength and impact strength are reduced and the resin composition is not suitable for preparing a sheet for internal boxes of a refrigerator. If the weight average molecular weight of the copolymer exceeds 200,000, a color change occurs during an extrusion process and there is a difficulty in an extrusion process into a sheet due to a poor fluidity.

The vinyl cyanide compound and the aromatic vinyl compound for preparing the copolymer (C) are the same as described above for preparing the graft polymer (A).

(D) Branched Copolymer of 30-35% by Weight of Vinyl Cyanide Compound and 70-65% by weight of Aromatic Vinyl Compound

The copolymer (D) having 28-35% by weight of a vinyl cyanide compound is prepared by copolymerizing 30-35% by weight of a vinyl cyanide compound and 70-65% by weight of an aromatic vinyl compound with a conventional initiator and a polyfunctional initiator to form a branched polymer. The weight average molecular weight of the copolymer (D) is preferably in the range of 350,000-450,000, and the molecular distribution (M_{w}/Mₙ) is preferably in 2.0-3.0. The branched copolymer (D) contrives excellent vacuum formability to a resin composition in comparison with a linear copolymer. If the weight average molecular weight of the copolymer (D) exceeds 450,000, a color change occurs during an extrusion process although the vacuum formability of the resin composition improves, on the other hand, if the weight average molecular weight of the copolymer (D) is less than 350,000, resin composition cannot provide a sufficient vacuum formability.

The vinyl cyanide compound and the aromatic vinyl compound for preparing the copolymer (D) are the same as described above for preparing the graft polymer (A).

A thermoplastic resin composition consisting of the graft polymer (A), the graft polymer (B) and the copolymer (C) only is resistant enough to HCHC 141b, but reduces impact strength, tensile strength, and vacuum formability. It is believed that the impact strength is reduced due to a poor compatibility of the graft polymer (A) with the copolymer (C) and the vacuum formability is reduced due to a low molecular weight of the copolymer (C). In order to improve the poor physical properties above, a copolymer (D) having a less content of a vinyl cyanide compound, a higher molecular weight than the copolymer (C) and having a branched structure is added in this invention. Since the copolymer (D) has a less content of a vinyl cyanide compound than the copolymer (C), the compatibility of the graft polymer (A) with the copolymer (C) may be improved, thereby a decrease of the impact strength of the resin composition can be prevented, and since the copolymer (D) has a highly branched structure and a higher molecular weight than the polymer (C), the tensile strength and vacuum formability of the resin composition can be improved.

The ratio by weight of (A)+(B) to (C)+(D) is from 50:50 to 20:80. This ratio has an important role in providing a good balance of physical properties such as impact strength and tensile strength of the resin composition. In case that the weight of (A)+(B) exceeds 50% by weight per the total weight of the resin composition, the tensile strength is reduced, on the other hand, if the weight is less than 20%, the impact strength is reduced, accordingly, the resin composition is not suitable for sheets for internal boxes. Further, the ratio by weight of the graft polymer (A) to the graft polymer (B) is from 10:1 to 1:1. It is believed that this ratio affects a chemical resistance and an impact strength. Generally, the graft polymer (B) is more resistant to HCFC 141b than the graft polymer (A), because an acrylic rubber is employed in the graft polymer (B), while the graft polymer (B) has a poorer impact strength than the graft polymer (A). Considering the both properties, the ratio by weight of the graft polymer (A) to the graft polymer (B) should be from 10:1 to 1:1.

The ratio by weight of the copolymer (C) to the copolymer (D) is from 10:1 to 5:1. It is believed that this ratio affects a freon resistance, an impact strength, fluidity and vacuum formability. If the copolymer (C) is employed in a more amount than the above, the impact strength and vacuum formability of the resin composition become poor, and if the copolymer (C) is employed in a less amount, a freon resistance is not good.

The invention may be better understood by reference to the following examples which are intended for the purpose of illustration and are not to be construed as in any way limiting the scope of the present invention, which is defined in the claims appended hereto.

### EXAMPLES

For preparing resin compositions according to this invention, each component of (A), (B), (C) and (D) was prepared as follow:

Preparation of Graft Polymer (A)

Polybutadiene latex of 45 parts (on the basis of solids content) having average rubber particle size of 0.3 μm, and deionized water of 200 parts were charged into a reactor having an agitator, a reflux cooling system, a thermostat and an feeding apparatus for additives. The mixture was agitated under a flow of nitrogen gas. During the agitation, 4% aqueous potassium perchlorate solution of 7 parts and monomer mixture consisting of styrene of 70 parts and acrylonitrile of 30 parts were added. The resulting mixture was polymerized at 70° C. adding continuously tert-dodecyl mercaptan of 0.1 parts over three hours and a rubber latex was obtained. The latex was dropped into an aqueous sulfuric acid solution heated at 90° C., and a precipitating material was obtained. The precipitating material was washed, dehydrated and dried, and the graft polymer (A) was obtained. The graft ratio of the polymer was 50%, and the acrylonitrile content was 28% by weight per the total weight of the polymer except rubber content.

Preparation of Acrylic Rubber

Butyl acrylate of 49 parts, triarylisocyanate of 0.5 parts, potassium rosinate of 2.0 parts and deionized water of 90 parts were charged into a reactor. The mixture was agitated at 45° C. for 40 minutes and was heated to 70° C. Potassium persulfate of 0.17 parts was added to the mixture. When the polymerization rate of the mixture reached to 60%, to the mixture was added continuously over two hours a mixture which had been prepared with butyl acrylate of 49.5 parts, triarylisocyanate of 1.0 parts, potassium rosinate of 0.5 parts and deionized water of 30 parts in a pre-emulsion state. When the polymerization rate of the mixture reached to 87%, potassium persulfate of 0.07 parts was added to the mixture and the polymerization was carried out at 70° C. The acrylic rubber latex having a polymerization of 98.3% was obtained.

Preparation of Graft Polymer (B)

The prepared acrylic rubber latex of 50 parts as a solids content, acrylonitrile of 6.25 parts, styrene of 18.75 parts and deionized water of 110 parts were charged into a reactor. The mixture was agitated at 45° C. over 50 minutes. To the mixture were added potassium rosinate of 0.45 parts, cumene hydroperoxide of 0.15 parts and tert-dodecyl mercaptan of 0.08 parts and the temperature was raised to 67° C. Then, polymerization was started by adding disodium ethylene diamine tetraacetate of 0.12 parts, sodium formaldehyde sulfoncylate of 0.25 parts and ferrous sulfate of 0.005 parts to the mixture. The polymerization at 67° C. was performed for four hours. When the polymerization rate of the mixture reached to 70%, a mixture which had been prepared with acrylonitrile of 6.25 parts, styrene of 18.75 parts, potassium rosinate of 0.8 parts, tert-dodecyl mercaptan of 0.1 parts, cumene hydroperoxide of 0.15 parts and deionized water of 40 parts in a pre-emulsion state was added continuously over three hours to the mixture. The temperature was kept at 78° C. and the polymerization was performed for one hour.

Preparation of Copolymer (C)

Deionized water of 160 parts and potassium oleate of 3 parts was charged into a nitrogen-substituted reactor. A first monomer mixture of styrene 20.2 parts and acrylonitrile 19.8 parts, and tert-dodecyl mercaptan of 0.25 parts were added into the reactor and emulsified. The mixture in the reactor was agitated raising the temperature to 60° C. Potassium persulfate of 0.3 parts was added to the mixture and polymerization was performed over 65 C. After polymerizing the first monomer mixture for thirty minutes, a second monomer mixture of styrene 32.8 parts and acrylonitrile 27.2 parts was added continuously over five hours, and the copolymer (C) was obtained. Acrylonitrile content was 40% by weight per the polymer prepared, weight average molecular weight determined by GPC was 140,000, and number average molecular weight was 68,000.

Preparation of Copolymer (D)

Deionized water of 160 parts and potassium oleate of 3 parts was charged into a nitrogen-substituted reactor. A first monomer mixture of styrene 23.2 parts and acrylonitrile 16.8 parts, tert-dodecyl mercaptan of 0.2 parts and divinyl benzene of 0.1 parts were added into the reactor and emulsified. The mixture in the reactor was agitated raising the temperature to 60° C. Potassium persulfate of 0.3 parts was added to the mixture and polymerization was performed over 65° C. After polymerizing the first monomer mixture for thirty minutes, a second monomer mixture of styrene 36.8 parts and acrylonitrile 23.2 parts was added continuously over five hours, and the copolymer (C) was obtained. Acrylonitrile content was 33% by weight per the polymer prepared, weight average molecular weight determined by GPC was 390,000, and number average molecular weight was 165,000.

### EXAMPLE 1

Using a tumbler mixer, the graft polymer (A) of 20 parts, the graft polymer (B) of 10 parts, the copolymer (C) of 60 parts and the copolymer (D) of 10 parts were premixed adding an anti-oxidant of 0.2 parts and a lubricating agent of 0.4 parts for ten minutes. The mixture was extruded into pellets with a diameter of 45 mm of twin screw extruder. The cylinder temperature of the extruder was kept at 220° C. and the screw was adjusted in 300 rpm. Test specimens for physical properties were prepared. Test specimens for a chemical resistance were prepared in a size of 30×150×2 mm by compression molding. For preparing the test specimens for a chemical resistance, the temperature of a heater was kept at 220° C., the compression time was two minutes, and the preheating time was two minutes. The composition of the components (A), (B), (C) and (D) and the test results are shown in Table 1.

Test Methods

For the test specimens prepared according to the examples, physical and chemical properties were measured as follow:

Tensile strength: It was measured according to ASTM D 638.

Impact strength: It was measured according to ASTM D 256.

Yellow index: It was measured according to ASTM D 1925.

Melt index: It was measured according to ASTM D 1238.

Tensile strength at high temperature: It was measured according to ASTM D 638 at 150° C. High tensile strength at 150° C. means good vacuum formability.

Freon resistance: A test specimen of 30×150×2 mm was fixed to a 1/4 ellipsoidal jig with an equation of 5X₂+24Y₂=1. HCFC 141b of 100 ml was added into a 5 l desiccator. Freon resistance was measured after keeping the test specimen at 30° C. for 8 hours. The test results are shown in Table 1.

### EXAMPLES 2-6

The procedure in Example 1 was carried out except that the contents of the components (A), (B), (C) and (D) were changed.

### COMPARATIVE EXAMPLES 1-6

The procedure in Example 1 was carried out except that the contents of the components (A), (B), (C) and (D) were changed, and that a component of them was excluded.

TABLE 1

| | Examples | | | | | | Comparative Examples | | | | | |
|---|---|---|---|---|---|---|---|---|---|---|---|---|
| | 1 | 2 | 3 | 4 | 5 | 6 | 1 | 2 | 3 | 4 | 5 | 6 |
| Graft polymer(A) | 20 | 15 | 27 | 20 | 30 | 15 | 10 | 30 | 20 | 20 | 40 | 10 |
| Graft polymer(B) | 10 | 15 | 3 | 10 | 15 | 7 | 20 | 0 | 10 | 10 | 20 | 5 |
| Copolymer (C) | 60 | 60 | 0 | 55 | 47 | 66 | 60 | 60 | 40 | 70 | 34 | 73 |
| Copolymer (D) | 10 | 10 | 10 | 5 | 8 | 11 | 10 | 10 | 30 | 0 | 6 | 12 |
| Tensile Strength | 490 | 492 | 490 | 495 | 450 | 550 | 492 | 493 | 515 | 475 | 390 | 600 |
| Impact Strength | 32 | 28 | 35 | 34 | 43 | 25 | 21 | 37 | 37 | 25 | 45 | 16 |
| Yellow Index | 15 | 13 | 18 | 12 | 16 | 15 | 10 | 20 | 10 | 20 | 17 | 16 |
| Chemical resistance | 1.5 | 2.0 | 1.3 | 1.2 | 2.0 | 1.4 | 2.0 | 0.5 | 0.7 | 2.0 | 2.0 | 0.4 |
| Tensile Strength | | | | | | | | | | | | |
| at High Temperature | 6.5 | 6.5 | 6.6 | 6.1 | 6.3 | 6.7 | 6.7 | 6.5 | 8.0 | 4.5 | 6.2 | 6.8 |
| Melt Index | 7.0 | 7.2 | 7.2 | 8.0 | 6.8 | 6.8 | 7.1 | 7.2 | 3.1 | 9.0 | 6.5 | 7.5 |

As shown in Table 1, Comparative Example 1 shows a low impact strength due to a low ratio of (A):(B), and Comparative Example 2 shows a poor freon resistance due to a use of the graft polymer (A) only. The freon resistance means a critical deformation and should be 1.0 or more for using in the internal box of a refrigerator. Comparative Example 3 shows a poor melt index due to a low ratio of (C):(D). Low melt index means that there is a difficulty in an extrusion process into a sheet due to a poor fluidity. Comparative Example 4 shows a low impact strength, low tensile strength at high temperature due to a use of the copolymer (C) only. Comparative Example 5 shows a low tensile strength due to a high ratio of (A)+(B):(C)+(D) of 6:4, and Comparative Example 6 shows a poor freon resistance and impact strength due to a low ratio of (A)+(B):(C)+(D) of 15:85.

It is shown that the thermoplastic resin compositions according to the present invention have good physical properties, easy vacuum formability, excellent impact strength, and freon resistance, especially excellent resistance to HCFC 141b thereby are capable of forming an internal box of a refrigerator.

It is apparent from the above that many modifications and changes are possible without departing from the spirit and scope of the present invention.

What is claimed is:

1. A thermoplastic resin composition having good chemical resistance and easy vacuum formability, which comprises:
(A) a graft polymer obtained by grafting in emulsion polymerization 100 parts by weight of a monomer mixture comprising 20-30% by weight of a vinyl cyanide compound and 80-70% by weight of an aromatic vinyl compound onto 2060 parts by weight of a diene rubber;
(B) a graft polymer obtained by grafting in emulsion polymerization 100 parts by weight of a monomer mixture comprising about 20-30% by weight of a vinyl cyanide compound and about 80-70% by weight of an aromatic vinyl compound onto 20-60 parts by weight of an acrylic rubber;
(C) a linear copolymer obtained by polymerizing a monomer mixture comprising 40-50% by weight of a vinyl cyanide compound and 60-50% by weight of an aromatic vinyl compound; and
(D) a branched copolymer obtained by polymerizing a monomer mixture comprising 30-35% by weight of a vinyl cyanide compound and 70-65% by weight of an aromatic vinyl compound,
wherein the ratio by weight of (A)+(B) to (C)+(D) is from 50:50 to 20:80, the ratio by weight of (A) to (B) is from 10:1 to 1:1, and the ratio by weight of (C) to (D) is from 10:1 to 5:1.

2. The resin composition according to claim 1 wherein the content of grafted polymer onto the diene rubber is 40-70% by weight based upon the total weight of the graft polymer (A) and the content of grafted polymer onto the acrylic rubber is 40-70% by weight based upon the total weight of the graft polymer (B).

3. The resin composition according to claim 1 wherein said vinyl cyanide compound is acrylonitrile or methacrylonitrile and said aromatic vinyl compound is selected from the group consisting of styrene, alpha-methylstyrene, para-methylstyrene, vinyl xylene, monochlorostyrene, dichlorostyrene and vinylnaphthalene.

4. The resin composition according to claim 1 wherein said diene rubber has an average particle size of 0.1-0.6 μm, and is selected from the group consisting of polybutadiene, polyisoprene, polychloroprene, a butadiene-styrene copolymer, and a butadiene-acrylonitrile copolymer and said acrylic rubber has an average particle size of 0.05-0.5 μm, and is made from an alkyl acrylate monomer having 2-8 carbon atoms.

5. The resin composition according to claim 1 wherein said copolymer (C) has 38-45% by weight of a vinyl cyanide compound, a weight average molecular weight of 100,000-200,000, a molecular weight distribution of 1.8-2.5 and a linear structure and said copolymer (D) has 28-35% by weight of a vinyl cyanide compound, a weight average molecular weight of 350,000-450,000, a molecular weight distribution of 2.0-3.0 and a branched structure.

6. A molded article for an internal box of a refrigerator produced from the composition of claim 1.
